(19) United States
(12) Patent Application Publication
(10) Pub. No.: US 2011/0284264 A1
(43) Pub. Date: Nov. 24, 2011

(54) CONDUCTOR OF HIGH VOLTAGE ELECTRICAL APPARATUS

(75) Inventors: Taehyun Kim, Tokyo (JP); Tomotaka Yano, Tokyo (JP)

(73) Assignee: Mitsubishi Electric Corporation, Chiyoda-ku, Tokyo (JP)

(21) Appl. No.: 13/146,303

(22) PCT Filed: Apr. 24, 2009
(86) PCT No.: PCT/JP2009/058167

§ 371 Date: Jul. 26, 2011

(51) Int. Cl. H01B 5/06

(52) U.S. Cl. 174/126.1

(57) ABSTRACT

In a conductor of a high voltage electrical apparatus, the conductor being placed in a vessel filled with insulating gas together with an electrical apparatus, the conductor is configured by a polygonal tubular conductor, and an opening portion which makes the insulating gas flowing in from an end portion of the polygonal tubular conductor flow out is formed in at least one surface of the polygonal tubular conductor. This aims to obtain the conductor of the high voltage electrical apparatus, the conductor being capable of achieving reduction in cost and high reliability.

### TECHNICAL FIELD

The present invention relates to a conductor of a high voltage electrical apparatus such as a gas insulated switchgear, the conductor being placed in a vessel filled with insulating gas such as SF₆ gas together with an electrical apparatus and, more particularly, relates to the structure of the conductor.

### BACKGROUND ART

A conductor of a high voltage electrical apparatus such as a gas insulated switchgear, the conductor being placed in a vessel filled with conventional insulating gas such as SF₆ gas together with an electrical apparatus, is generally configured by a conductor formed in the shape of a rectangle in section or in a rectangular shape. A large current is energized in the high voltage electrical apparatus; and therefore, a temperature rise of the conductor increases. In order to suppress this, countermeasures are made by increasing the plate thickness or the plate width of the conductor formed in the rectangular shape to increase a sectional area to reduce conductor resistance. In the case of alternating current energization, current is difficult to flow in a conductor's central portion and has many components flowing along the surface of the conductor due to skin effect; alternating current resistance of the conductor is not proportional to the sectional area of the conductor, but is substantially in inverse proportion to the surface area of the conductor. Therefore, the surface area thereof is obtained by increasing the plate thickness or the plate width of the conductor formed in the rectangular shape. Furthermore, in the case where two conductors are connected, an end portion of one side conductor and an end portion of other side conductor are overlapped and portions where both are overlapped are fastened by bolts and nuts; and accordingly, two conductors are firmly electrically connected. In the case where the conductors formed in the rectangular shape are fastened by the bolts and the nuts as described above, electric field relaxation means for securing withstand voltage performance is applied to the bolts and the nuts. Incidentally, the conductor formed in the rectangular shape is cooled by convection of the insulating gas filled in the case.

Furthermore, also in the case where a conductor is not formed in a rectangular shape but is formed in a cylindrical shape, when a large current is energized, a temperature rise of the conductor similarly increases. In order to suppress this, countermeasures are made by increasing the outer diameter of the cylindrical shaped conductor to increase a sectional area to reduce conductor resistance. In the case of alternating current energization, current has many components flowing along the surface of the conductor due to skin effect; alternating current resistance of the conductor is not proportional to the sectional area of the conductor, but is substantially in inverse proportion to the surface area of the conductor. Therefore, the surface area thereof is obtained by increasing the outer diameter of the cylindrical shaped conductor.

As described above, in the case of the conductor formed in the rectangular shape or the cylindrical shape, each conductor needs to be configured to be large; and along with that, a problem exit in that a tank that contains the conductor is to be large in order to secure insulation distance and the weight of the apparatus also increases.

A conventional improved conductor is not formed in a cylindrical shape but is formed in a hollow cylinder and an axially parallel elongated slit is formed in the hollow cylindrical conductor from one side end face to just before the other side end face to increase the surface area of the conductor; and accordingly, alternating current resistance is suppressed so as to be small without increasing the outer diameter of the conductor.
Patent Document 1: Japanese Unexamined Patent Publication No. H4-101306

### DISCLOSURE OF THE INVENTION

### Problem to be Solved by the Invention

The aforementioned conventional conductor of the high voltage electrical apparatus is the hollow cylindrical conductor; and accordingly, a central portion in which current does not flow due to skin effect is formed in a hollow shape to reduce the amount of the conductor and to enlarge the surface area due to the elongated slit, and thus heat dissipation effect is promoted.

However, the conductor is the hollow cylindrical conductor; and therefore, the conductor has a shape that is difficult to connect to an electrical component and other conductor in the high voltage electrical apparatus. A connection flat portion needs to be formed at an end portion of the hollow cylindrical conductor by processing a surface to be a flat surface. Alternatively, a connection component in which a circular arc shape is formed inside the hollow cylindrical conductor needs to be processed and manufactured. Both have a problem in that the cost of processing increases.

The present invention has been made to solve the problem described above, and an object of the present invention is to obtain a conductor of a high voltage electrical apparatus, the conductor being capable of achieving reduction in cost and high reliability.

### Means for Solving Problem

According to the present invention, there is provided a conductor of a high voltage electrical apparatus, the conductor being placed in a vessel filled with insulating gas together with an electrical apparatus. In the conductor of the high voltage electrical apparatus, the conductor is configured by a polygonal tubular conductor, and an opening portion serving as a path of the insulating gas is formed in at least one surface of the polygonal tubular conductor. The polygonal tubular conductor is configured by a first polygonal tubular conductor and a second polygonal tubular conductor; and a connection conductor and fasteners are provided, the first polygonal tubular conductor and the second polygonal tubular conductor being connected by the connection conductor and being fastened with the fasteners. Fastening portions of the first polygonal tubular conductor and the second polygonal tubular conductor are formed with concave portions each located on the side of the first polygonal tubular conductor and on the side of the second polygonal tubular conductor, and head portions of the fasteners are contained in the concave portions.

### Effect of the Invention

In a conductor of a high voltage electrical apparatus according to the present invention, the conductor is configured by a polygonal tubular conductor, an opening portion is formed in at least one surface of the polygonal tubular conductor, and insulating gas which flows in from an end portion of the polygonal tubular conductor is made to flow out from the opening portion; whereby, a conductor of a high voltage electrical apparatus can be obtained, the conductor being capable of achieving reduction in cost and high reliability.

### BRIEF DESCRIPTION OF THE DRAWINGS

FIG. 1 is a perspective view showing a conductor of a high voltage electrical apparatus according to Embodiment 1 of the present invention;

FIG. 2 is a sectional view showing the conductor of the high voltage electrical apparatus according to Embodiment 1 of the present invention;

FIG. 3 is a relevant part sectional view showing the conductor of the high voltage electrical apparatus according to Embodiment 1 of the present invention;

FIG. 4 is a perspective view showing other example of a conductor of a high voltage electrical apparatus according to Embodiment 1 of the present invention;

FIG. 5 is a perspective view showing a conductor of a high voltage electrical apparatus according to Embodiment 2 of the present invention;

FIG. 6 is a relevant part sectional view showing the conductor of the high voltage electrical apparatus according to Embodiment 2 of the present invention; and

FIG. 7 is a perspective view showing other example of a conductor of a high voltage electrical apparatus according to Embodiment 2 of the present invention.

FIG. 8 is a side view showing other example of a conductor of a high voltage electrical apparatus according to Embodiment 2 of the present invention;

FIG. 9 is a side view showing other example of a conductor of a high voltage electrical apparatus according to Embodiment 2 of the present invention;

FIG. 10 is a side view showing other example of a conductor of a high voltage electrical apparatus according to Embodiment 2 of the present invention; and

FIG. 11 is a side view showing other example of a conductor of a high voltage electrical apparatus according to Embodiment 2 of the present invention.

FIG. 12 is a side view showing, in a partial section, a conductor of a high voltage electrical apparatus according to Embodiment 3 of the present invention;

FIG. 13 is a side view showing, in a partial section, other example of a conductor of a high voltage electrical apparatus according to Embodiment 3 of the present invention; and

FIG. 14 is a side view showing, in a partial section, other example of a conductor of a high voltage electrical apparatus according to Embodiment 3 of the present invention.

FIG. 15 is a side view showing, in a partial section, a conductor of a high voltage electrical apparatus according to Embodiment 4 of the present invention;

FIG. 16 is a side view showing, in a partial section, other example of a conductor of a high voltage electrical apparatus according to Embodiment 4 of the present invention;

FIG. 17 is a side view showing, in a partial section, a conductor of a high voltage electrical apparatus according to Embodiment 5 of the present invention;

FIG. 18 is a side view showing, in a partial section, other example of a conductor of a high voltage electrical apparatus according to Embodiment 5 of the present invention;

FIG. 19 is a side view showing, in a partial section, other example of a conductor of a high voltage electrical apparatus according to Embodiment 5 of the present invention; and

FIG. 20 is a sectional view showing a conductor of a high voltage electrical apparatus according to Embodiment 6 of the present invention.

FIG. 21 is a sectional view showing a conductor of a high voltage electrical apparatus according to Embodiment 7 of the present invention;

FIG. 22 is a sectional view taken along the line X-X in FIG. 21, the sectional view showing the conductor of the high voltage electrical apparatus according to Embodiment 7 of the present invention;

FIG. 23 is a side sectional view showing a conductor of a high voltage electrical apparatus according to Embodiment 8 of the present invention; and

FIG. 24 is a side view showing a conductor of a high voltage electrical apparatus according to Embodiment 9 of the present invention.

FIG. 25 is a side view showing a conductor of a high voltage electrical apparatus according to Embodiment 10 of the present invention;

FIG. 26 is a side view showing a conductor of a high voltage electrical apparatus according to Embodiment 11 of the present invention;

FIG. 27 is a side view showing a conductor of a high voltage electrical apparatus according to Embodiment 12 of the present invention;

FIG. 28 is a side view showing a conductor of a high voltage electrical apparatus according to Embodiment 13 of the present invention;

FIG. 29 is a perspective view showing a conductor of a high voltage electrical apparatus according to Embodiment 14 of the present invention;

FIG. 30 is a perspective view showing a conductor of a high voltage electrical apparatus according to Embodiment 15 of the present invention; and

FIG. 31 is a perspective view showing a conductor of a high voltage electrical apparatus according to Embodiment 16 of the present invention.

### BEST MODE FOR CARRYING OUT THE INVENTION

### Embodiment 1

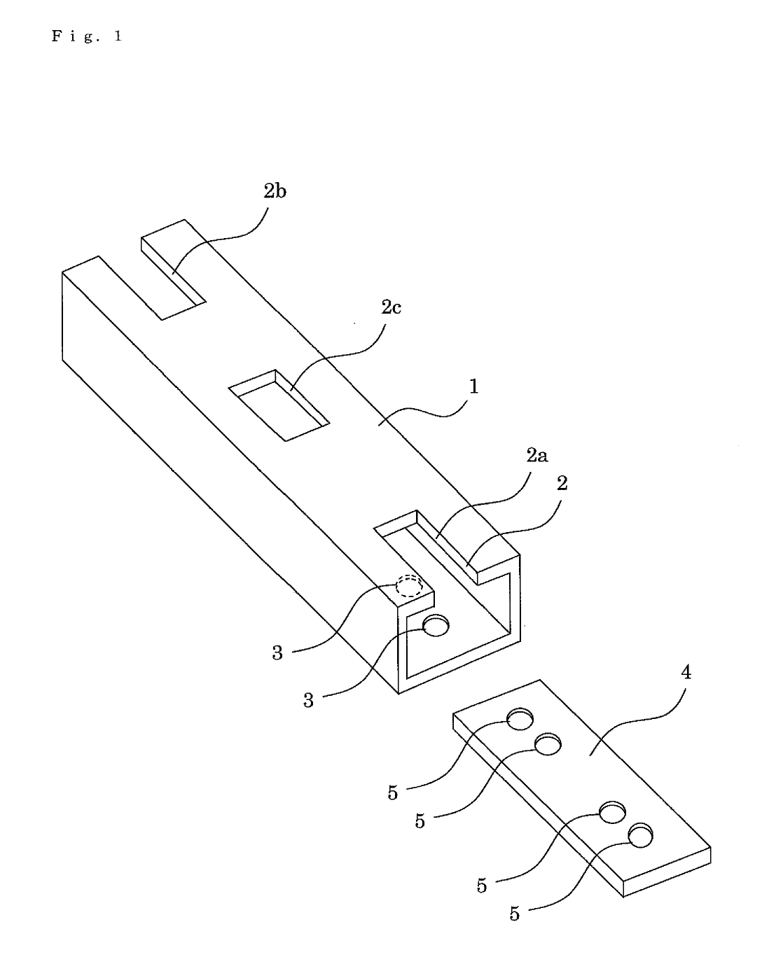

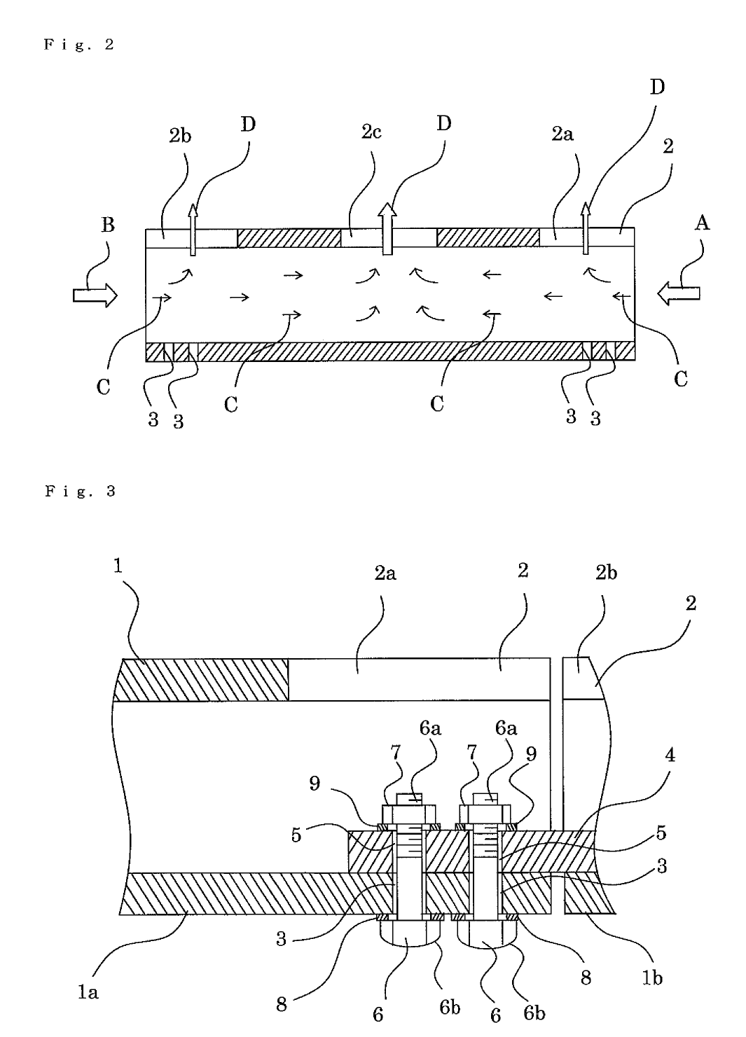

Hereinafter, Embodiment 1 of the present invention will be described with reference to FIG. 1 to FIG. 3. FIG. 1 is a perspective view showing a conductor of a high voltage electrical apparatus according to Embodiment 1 of the present invention. FIG. 2 is a sectional view showing the conductor of the high voltage electrical apparatus according to Embodiment 1 of the present invention. FIG. 3 is a relevant part sectional view showing the conductor of the high voltage electrical apparatus according to Embodiment 1 of the present invention.

In these respective drawings, reference numeral 1 denotes a polygonal tubular conductor formed from, for example, a square tube and is made of copper or aluminum. 2 denotes opening portions formed in at least one surface, for example, in an upper surface of the polygonal tubular conductor 1; and insulating gas such as SF₆ gas, which flows in from both end portions of the polygonal tubular conductor 1 or from the directions of arrows A and B and flows in the polygonal tubular conductor 1 in the directions of arrows C, is made to flow out from the opening portions in the directions of arrows D. Opening portions 2a and 2b are formed on both end portions of the polygonal tubular conductor 1 and are opened to end faces of the both end portions. An opening portion 2c is formed between the opening portion 2a and the opening portion 2b; and the drawing shows that the opening portion 2c is formed at one position as an example. The opening portion 2c can be formed in plural number depending on cooling characteristics of the polygonal tubular conductor 1. Furthermore, the opening portion 2c has opening dimensions that are arbitrarily set depending on the cooling characteristics of the polygonal tubular conductor 1. 3 denotes through holes that are respectively formed at both end portions of the polygonal tubular conductor 1 and are located on the lower sides of the opening portions 2a and 2b.

4 denotes a connection conductor made of, for example, copper or aluminum and is for connecting a first polygonal tubular conductor 1a and a second polygonal tubular conductor 1b in the case where the polygonal tubular conductor 1 is configured by the first polygonal tubular conductor 1a and the second polygonal tubular conductor 1b; and the connection conductor 4 has through holes 5 that are formed so as to be arranged at the positions of the through holes 3 formed at the end portions of the polygonal tubular conductor 1. 6 denotes bolts which are passed through the through holes 3 formed at the end portions of the polygonal tubular conductor 1 and the through holes 5 of the connection conductor 4; and 6a denotes threaded portions of the bolts 6. 7 denotes nuts that are screwed to the threaded portions 6a of the bolts 6 to firmly fasten the first polygonal tubular conductor 1a and the connection conductor 4 to electrically connect. 8 and 9 denote washers. Incidentally, although not shown in the drawing, the second polygonal tubular conductor 1b and the connection conductor 4 are also firmly fastened by the bolts 6 and the nuts 7 so as to be electrically connected.

Next, operation will be described. The polygonal tubular conductor 1 can increase a conductor surface area while suppressing an increase of alternating current resistance due to skin effect during alternating current energization, the polygonal tubular conductor 1 has a structure provided with a large space by eliminating a conductor's central portion that does not contribute to electrical conduction due to the skin effect, and the polygonal tubular conductor 1 can reduce the conductor's central portion without increasing loss during the alternating current energization; and therefore, the polygonal tubular conductor 1 can effectively perform an increase of energization capacity and can reduce the cost of materials.

Furthermore, as shown in FIG. 2, the opening portions 2a, 2b, and 2c are formed in, for example, the upper surface of the polygonal tubular conductor 1; accordingly, the insulating gas such as SF₆ gas, which flows in from both end portions of the polygonal tubular conductor 1 or from the directions of arrows A and B and flows in the polygonal tubular conductor 1 in the directions of arrows C, is made to flow out from the opening portions 2a, 2b, and 2c in the directions of arrows D; and thus, the polygonal tubular conductor 1 can be effectively cooled by circulation of the insulating gas. The size of the opening portions 2a, 2b, and 2c is set so as to be an optimum gas flow rate; and accordingly, the cooling effect of the whole conductor can be promoted by controlling to a predetermined gas flow rate.

By the way, in the case where the polygonal tubular conductor 1 is configured by the first polygonal tubular conductor 1a and the second polygonal tubular conductor 1b, the first polygonal tubular conductor 1a and the second polygonal tubular conductor 1b can be connected to the connection conductor 4 as shown in FIG. 3. That is, the positions of the through holes 3 respectively formed in the end portions of the first polygonal tubular conductor 1a and the second polygonal tubular conductor 1b and the positions of the through holes 5 formed in the connection conductor 4 are arranged so as to be aligned, the'bolts 6 are passed through the through holes 3 and the through holes 5 via the washers 8, and the nuts 7 are screwed and fastened to the threaded portions 6a of the bolts 6 via the washers 9; and accordingly, the first polygonal tubular conductor 1a and the second polygonal tubular conductor 1b are firmly electrically connected via the connection conductor 4.

The inside of the first polygonal tubular conductor 1a and the second polygonal tubular conductor 1b in this Embodiment 1 is a substantially constant electric field distribution. As a result, as for the threaded portion 6a of the bolt 6 and the nut 7 located at the inside of the first polygonal tubular conductor 1a and the second polygonal tubular conductor 1b, the aforementioned conventional electric field relaxation means for securing withstand voltage performance does not need to be applied. Incidentally, a head portion 6b of the bolt 6 located at the outside of the first polygonal tubular conductor 1a and the second polygonal tubular conductor 1b is formed in a round shape by eliminating corner portions; and accordingly, an electric field can be relaxed and withstand voltage performance can be improved.

Furthermore, the structure of connection between the first polygonal tubular conductor 1a and the connection conductor 4 and the structure of connection between the second polygonal tubular conductor 1b and the connection conductor 4 are each a connection between flat portions and can be simply configured as compared to the structure of connection of the aforementioned conventional hollow cylinder conductor.

Further, the opening portions 2a and 2b formed at the end portions of the first polygonal tubular conductor 1a and the second polygonal tubular conductor 1b are provided on the upper side of the connection positions of the bolts 6 and the nuts 7, and the opening portions 2a and 2b have the size of openings opened to the end faces of the first polygonal tubular conductor 1a and the second polygonal tubular conductor 1b; and therefore, fastening work of the bolts 6 and the nuts 7 can be easily performed. Furthermore, the fastening work of the bolts 6 and the nuts 7 can be easily performed; and therefore, the fastening can be easily performed by regular torque, contact performance is enhanced, low connection resistance can be maintained, and heat generation can be suppressed.

By the way, in the case where the first polygonal tubular conductor 1a and the second polygonal tubular conductor 1b are connected to the connection conductor 4, the insulating gas flows in from the opening portion 2a of the first polygonal tubular conductor 1a and the opening portion 2b of the second polygonal tubular conductor 1b and flows out from the opening portions 2c and 2b of the first polygonal tubular conductor 1a and the opening portions 2c and 2a of the second polygonal tubular conductor 1b; and accordingly, the first polygonal tubular conductor 1a and the second polygonal tubular conductor 1b can be cooled.

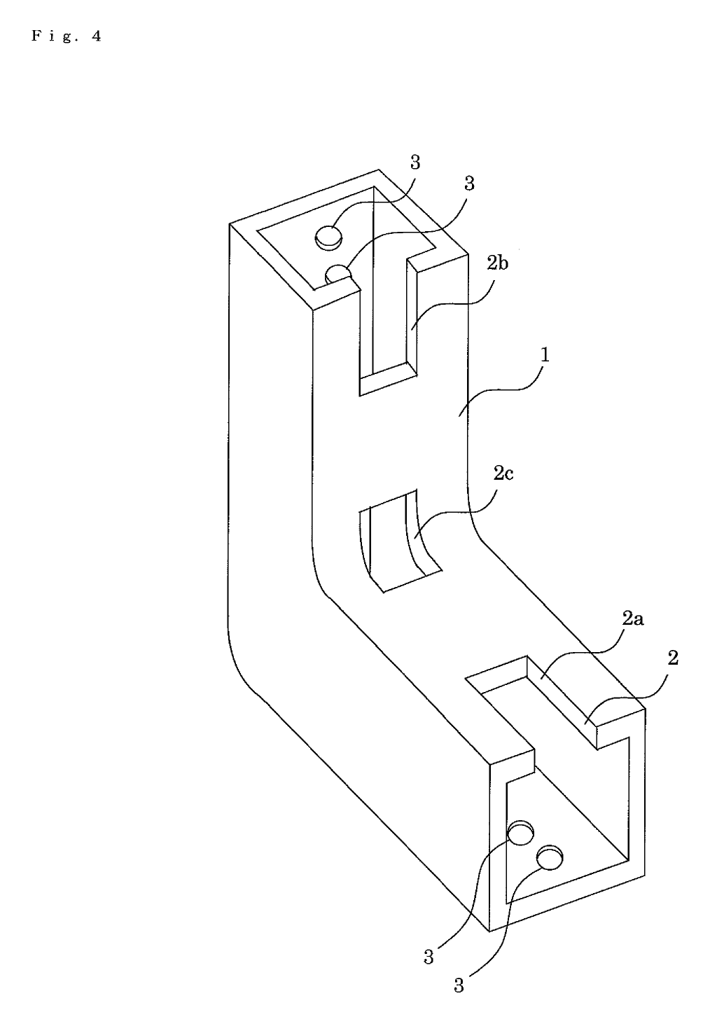

Furthermore, the polygonal tubular conductor 1 shown in FIG. 1 describes the case where the polygonal tubular conductor 1 is formed in a straight shape. However, in the case where the polygonal tubular conductor 1 cannot be arranged at a corner portion or straightly, a structure bent at substantially 90 degrees can be made as shown in FIG. 4. In other words, a structure bent at any curvature can be made.

### Embodiment 2

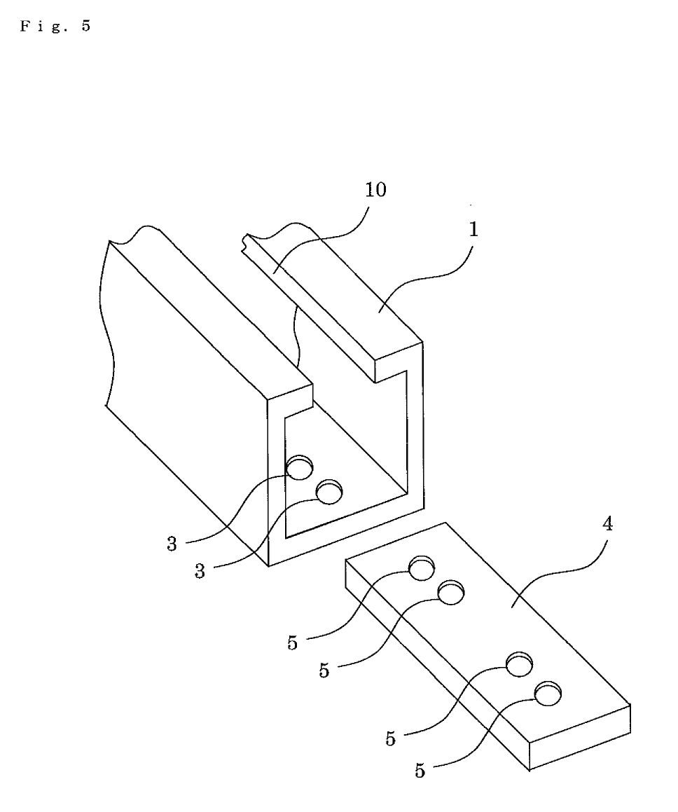

Embodiment 2 of the present invention will be described with reference to FIG. 5 and FIG. 6. FIG. 5 is a perspective view showing a conductor of a high voltage electrical apparatus according to Embodiment 2 of the present invention. FIG. 6 is a relevant part sectional view showing the conductor of the high voltage electrical apparatus according to Embodiment 2 of the present invention.

In these respective drawings, reference numeral 1 denotes a polygonal tubular conductor; 1a denotes a first polygonal tubular conductor; 1b denotes a second polygonal tubular conductor; 3 denotes a through hole; 4 denotes a connection conductor; 5 denotes a through hole; 6 denotes a bolt; 6a denotes a threaded portion, 6b denotes a head portion; 7 denotes a nut; 8 denotes a washer; and 9 denotes a washer. 10 denotes an opening portion formed in at least one surface, for example, in an upper surface of the polygonal tubular conductor 1, the opening portion being brought into communication with both end portions of the polygonal tubular conductor 1; and insulating gas such as SF₆ gas, which flows in from both end portions of the polygonal tubular conductor 1 and flows in the polygonal tubular conductor 1, is made to flow out from the opening portion. That is, the opening portion 10 is formed in the upper surface of the polygonal tubular Conductor 1 and is brought into communication with both end faces in the longitudinal direction of the conductor. In other words, the opening portion 10 constitutes a space where any member does not exist from one side end face to the other side end face of the polygonal tubular conductor 1.

Also in this Embodiment 2, as in the aforementioned Embodiment 1, the polygonal tubular conductor 1 can increase a conductor surface area while suppressing an increase of alternating current resistance due to skin effect during alternating current energization, the polygonal tubular conductor 1 has a structure provided with a large space by eliminating a conductor's central portion that does not contribute to electrical conduction due to the skin effect, and the polygonal tubular conductor 1 can reduce the conductor's central portion without increasing loss during the alternating current energization; and therefore, the polygonal tubular conductor 1 can effectively perform an increase of energization capacity and can reduce the cost of materials.

Furthermore, the insulating gas such as SF₆ gas, which flows in from both end portions of the polygonal tubular conductor 1 and flows in the polygonal tubular conductor 1, is made to flow out from the opening portion 10; and thus, the polygonal tubular conductor can be effectively cooled by circulation of the insulating gas. The size of the opening portion 10 is set so as to be an optimum gas flow rate; and accordingly, the cooling effect of the whole conductor can be promoted by controlling to a predetermined gas flow rate.

By the way, in the case where the polygonal tubular conductor 1 is configured by the first polygonal tubular conductor 1a and the second polygonal tubular conductor 1b, the first polygonal tubular conductor 1a and the second polygonal tubular conductor 1b can be connected to the connection conductor 4 as shown in FIG. 6. That is, the positions of the through holes 3 respectively formed in the end portions of the first polygonal tubular conductor 1a and the second polygonal tubular conductor 1b and the positions of the through holes 5 formed in the connection conductor 4 are arranged so as to be aligned, the bolts 6 are passed through the through holes 3 and the through holes 5 via the washers 8, and the nuts 7 are screwed and fastened to the threaded portions 6a of the bolts 6 via the washers 9; and accordingly, the first polygonal tubular conductor 1a and the second polygonal tubular conductor 1b are firmly electrically connected via the connection conductor 4.

The inside of the first polygonal tubular conductor la and the second polygonal tubular conductor 1b in this Embodiment 2 is a substantially constant electric field distribution. As a result, as for the threaded portion 6a of the bolt 6 and the nut 7 located at the inside of the first polygonal tubular conductor 1a and the second polygonal tubular conductor 1b, the aforementioned conventional electric field relaxation means for securing withstand voltage performance does not need to be applied. Incidentally, a head portion 6b of the bolt 6 located at the outside of the first polygonal tubular conductor 1a and the second polygonal tubular conductor 1b is formed in a round shape by eliminating corner portions; and accordingly, an electric field can be relaxed and withstand voltage performance can be improved.

Furthermore, also in this Embodiment 2, the structure of connection between the first polygonal tubular conductor 1a and the connection conductor 4 and the structure of connection between the second polygonal tubular conductor 1b and the connection conductor 4 are each a connection between flat portions and can be simply configured as compared to the structure of connection of the aforementioned conventional hollow cylinder conductor.

Further, the opening portions 10 each brought into communication with both end faces in the longitudinal direction of the first polygonal tubular conductor 1a and the second polygonal tubular conductor 1b are provided on the upper side of the connection positions of the bolts 6 and the nuts 7; and therefore, fastening work of the bolts 6 and the nuts 7 can be easily performed. Furthermore, the fastening work of the bolts 6 and the nuts 7 can be easily performed; and therefore, the fastening can be easily performed by regular torque, contact performance is enhanced, low connection resistance can be maintained, and heat generation can be suppressed.

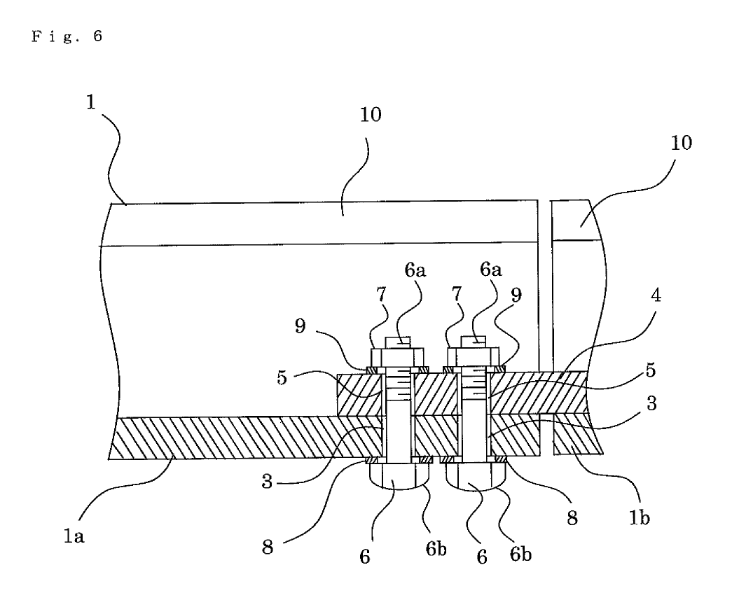

Furthermore, the polygonal tubular conductor 1 shown in FIG. 5 describes the case where the polygonal tubular conductor 1 is formed in a straight shape. However, in the case where the polygonal tubular conductor 1 cannot be arranged at a corner portion or straightly, a structure bent at substantially 90 degrees can be made as shown in FIG. 7. In other words, a structure bent at any curvature can be made.

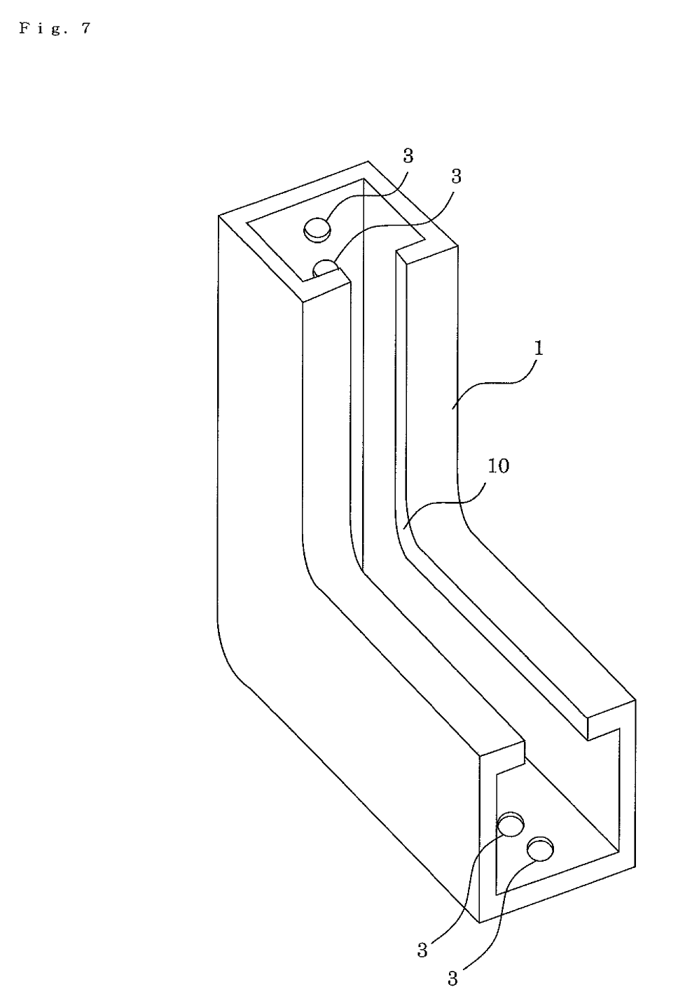

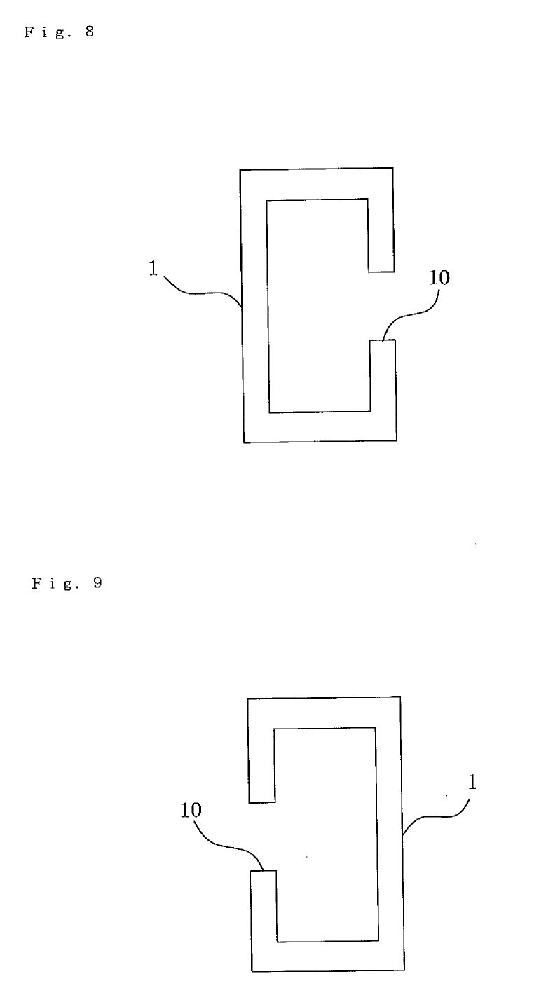

By the way, in FIG. 5, the description has been made on the case where the opening portion 10 is formed in the upper surface of the polygonal tubular conductor 1, but is not limited thereto. An opening portion 10 may be formed in the right side surface of a polygonal tubular conductor 1 as shown in FIG. 8, an opening portion 10 may be formed in the left side surface of a polygonal tubular conductor 1 as shown in FIG. 9, an opening portion 10 may be formed in a lower surface of a polygonal tubular conductor 1 as shown in FIG. 10, and the same effects are exhibited. As described above, as for the position of the opening portion 10, the opening portion 10 can be formed at an appropriate position depending on the state of airflow of the insulating gas of a conductor installation portion in the high voltage electrical apparatus. Furthermore, an increase of a surface area can be achieved; and therefore, heat dissipation effect is also promoted and thus a temperature rise can be suppressed even when the position of the opening portion 10 is located at any position.

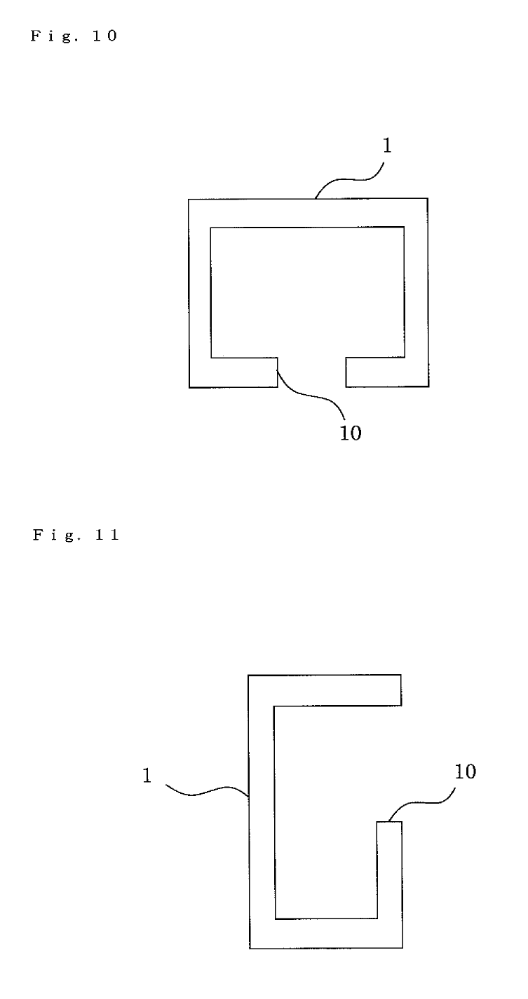

Furthermore, FIG. 8 shows the case where the opening portion 10 formed in the right side surface of the polygonal tubular conductor 1 is located at a central portion, the opening portion 10 may be formed in the upper side of the right side surface of the polygonal tubular conductor 1 as shown in FIG. 11; and in this case, insulating gas warmed in the polygonal tubular conductor 1 is easy to flow out from the opening portion 10 formed in the upper side of the right side surface of the polygonal tubular conductor 1 to the outside of the conductor by convection and therefore the cooling effect is further improved. Incidentally, although not shown in the drawing, the opening portion 10 may be formed in the upper side of the left side surface of the polygonal tubular conductor 1, and the same effects are exhibited.

### Embodiment 3

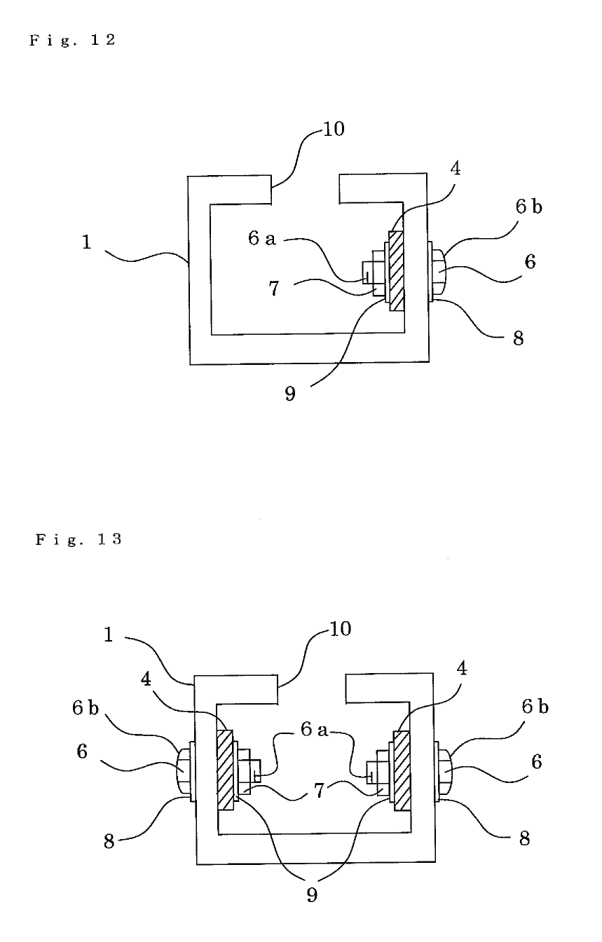

Embodiment 3 of the present invention will be described with reference to FIG. 12. The description has been made on the case where the connection conductor 4 is placed on the inner surface of the lower surface side of the polygonal tubular conductor 1 in the aforementioned Embodiments 1 and 2; however, in FIG. 12, a connection conductor 4 is placed on the inner surface of the right side surface side of a polygonal tubular conductor 1 and the same effects as Embodiments 1 and 2 are exhibited. Incidentally, although not shown in the drawing, the opening portion 10 may be placed on the inner surface of the left side surface side of the polygonal tubular conductor 1, and the same effects are exhibited.

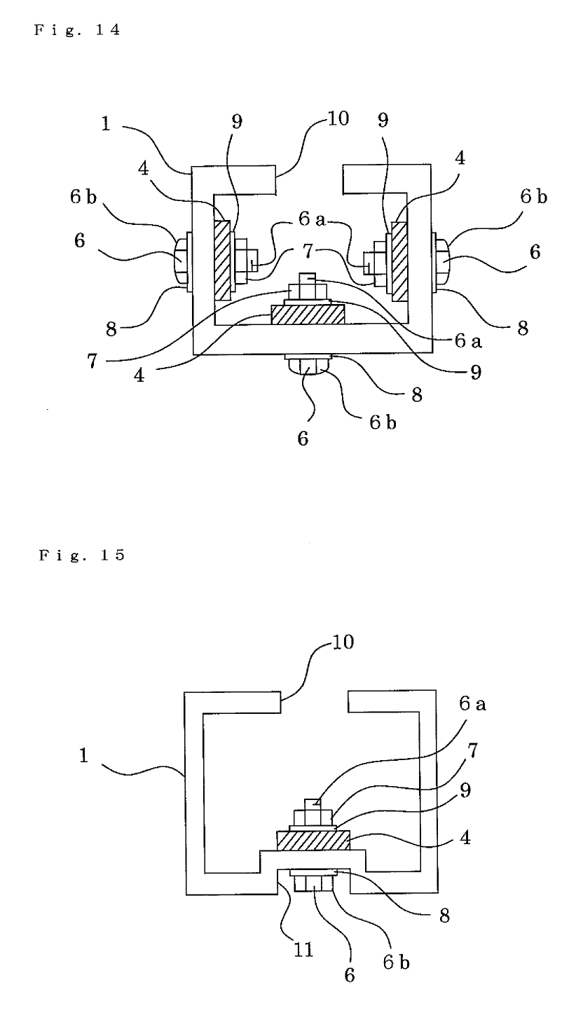

Furthermore, FIG. 13 shows an arrangement in which connection conductor 4 is dispersed at the inner surface of the left side surface side and the inner surface of the right side surface side of a polygonal tubular conductor 1; and FIG. 14 shows an arrangement in which connection conductor 4 is dispersed at the inner surface of the lower surface side, the inner surface of the left side surface side, and the inner surface of the right side surface side of a polygonal tubular conductor 1. As described above, the connection conductor 4 is dispersed and arranged; accordingly, energization capacity as one connection conductor 4 can be reduced; and therefore, connection resistance can be reduced and heat generation can be further suppressed.

### Embodiment 4

Embodiment 4 of the present invention will be described with reference to FIG. 15. In FIG. 15, a concave portion 11 is formed at a fastening portion of a polygonal tubular conductor 1 and a head portion 6b of a bolt 6 serving as a fastener is contained in the concave portion 11. That is, the depth of the concave portion 11 formed at the fastening portion of the polygonal tubular conductor 1 is formed to be deeper than the height of the head portion 6b of the bolt 6; and when the head portion 6b of the bolt 6 is contained in the concave portion 11, the edge surface of the head portion 6b of the bolt 6 is configured so as not to protrude from the outer surface of the lower surface side of the polygonal tubular conductor 1. Accordingly, an electric field of the head portion 6b of the bolt 6 can be relaxed, a special bolt 6 whose head portion 6b of the bolt 6 is formed in the round shape does not need to be used as in the aforementioned respective embodiments, a general and inexpensive bolt 6 is used, and the conductor can be connected while securing withstand voltage performance; and therefore, cost reduction can be achieved.

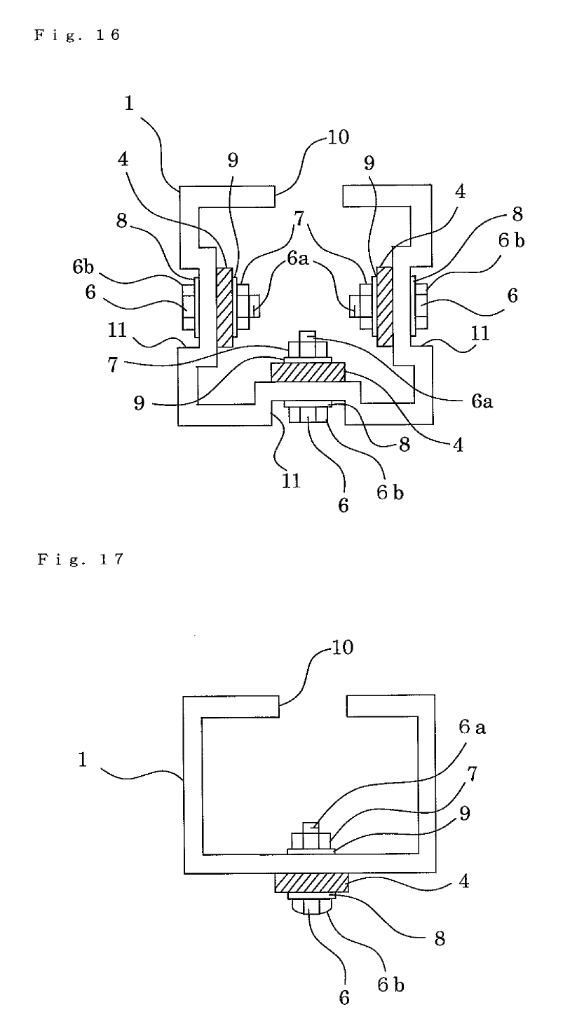

Furthermore, FIG. 16 shows the case where this Embodiment 4 is applied to the configuration of FIG. 14 and the same effects are exhibited. Incidentally, although not shown in the drawing, this Embodiment 4 can also be applied to the configuration of FIG. 12 and FIG. 13, and the same effects are exhibited.

By the way, the description has been made on the case where the concave portion 11 is formed at only the fastening portion of the polygonal tubular conductor 1; however, in order to obtain effects from the view point of processing, the concave portion 11 may be longitudinally formed across the whole length of the polygonal tubular conductor 1. In the case of forming the concave portion 11 across the whole length as described above, the forming can be preliminarily made by drawing process, bending process, and the like in manufacturing the conductor; and therefore, the conductor manufactured by these process is cut to length as needed to be able to serve as the polygonal tubular conductor 1.

### Embodiment 5

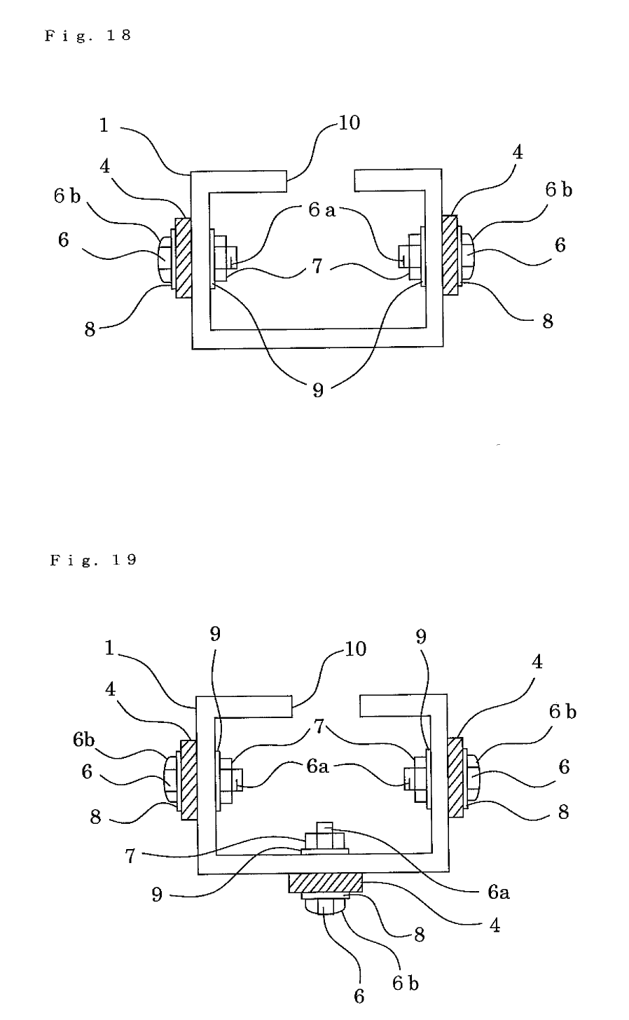

Embodiment 5 of the present invention will be described with reference to FIG. 17 to FIG. 19. In the aforementioned respective embodiments, the description has been made on the case where the connection conductor 4 is placed on the inner surfaces of the polygonal tubular conductor 1, respectively. However, in this Embodiment 5, connection conductor 4 is placed on the outer surfaces of a polygonal tubular conductor 1, respectively; and accordingly, a surface area as the conductor increases and cooling effect can be further improved. FIG. 17 shows the case where the connection conductor 4 is placed on the outer surface of the lower surface side of the polygonal tubular conductor 1, FIG. 18 shows the case where the connection conductor 4 is placed on the outer surfaces of both side surface sides of the polygonal tubular conductor 1, and FIG. 19 shows the case where the connection conductor 4 is placed on the outer surface of the lower surface side and on the outer surfaces of both side surface sides of the polygonal tubular conductor 1. Incidentally, although not shown in the drawing; the connection conductor 4 may be placed on either one of the outer surfaces of both side surface sides of the polygonal tubular conductor 1.

### Embodiment 6

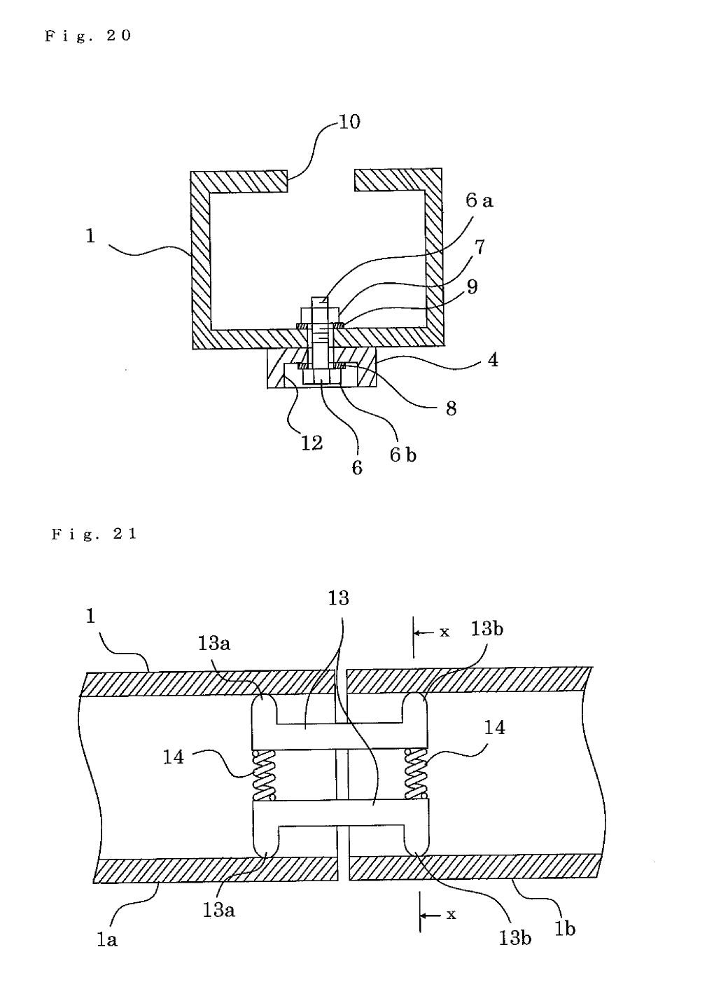

Embodiment 6 of the present invention will be described with reference to FIG. 20. In FIG. 20, a concave portion 12 is formed by, for example, spot facing processing at a fastening portion of a connection conductor 4 placed on the outer surface of the lower surface side of a polygonal tubular conductor 1 and a head portion 6b of a bolt 6 serving as a fastener is contained in the concave portion 12. That is, the depth of the concave portion 12 formed at the fastening portion of the connection conductor 4 is formed to be deeper than the height of the head portion 6b of the bolt 6; and when the head portion 6b of the bolt 6 is contained in the concave portion 12, the edge surface of the head portion 6b of the bolt 6 is configured so as not to protrude from the outer surface of the lower surface side of the connection conductor 4. Accordingly, an electric field of the head portion 6b of the bolt 6 can be relaxed, a special bolt 6 whose head portion 6b of the bolt 6 is formed in the round shape does not need to be used, a general and inexpensive bolt 6 is used, and the conductor can be connected while securing withstand voltage performance; and therefore, cost reduction can be achieved.

Furthermore, this Embodiment 6 can also be applied to the configuration shown in FIG. 18 and FIG. 19 and the same effects are exhibited.

### Embodiment 7

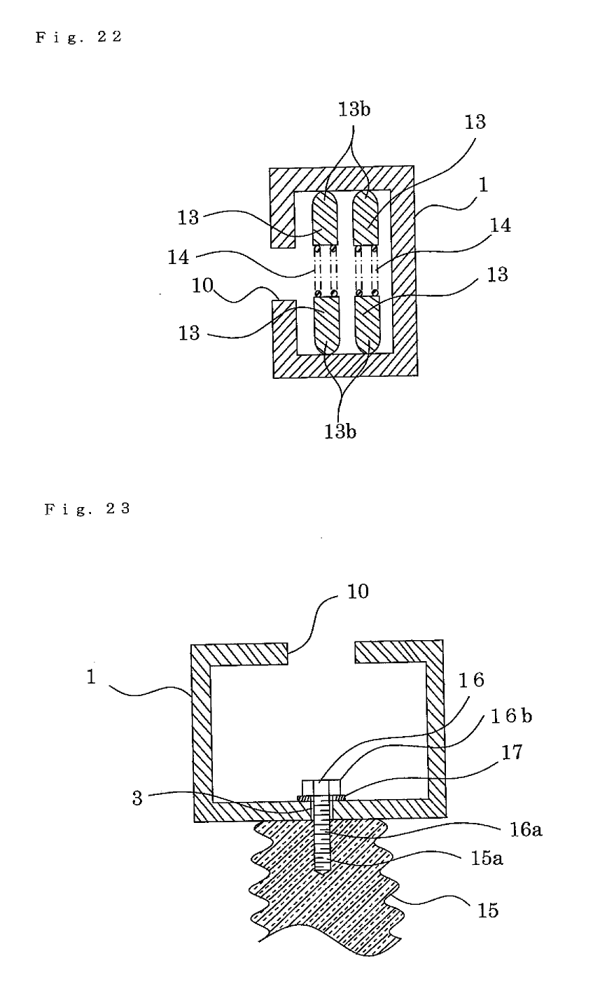

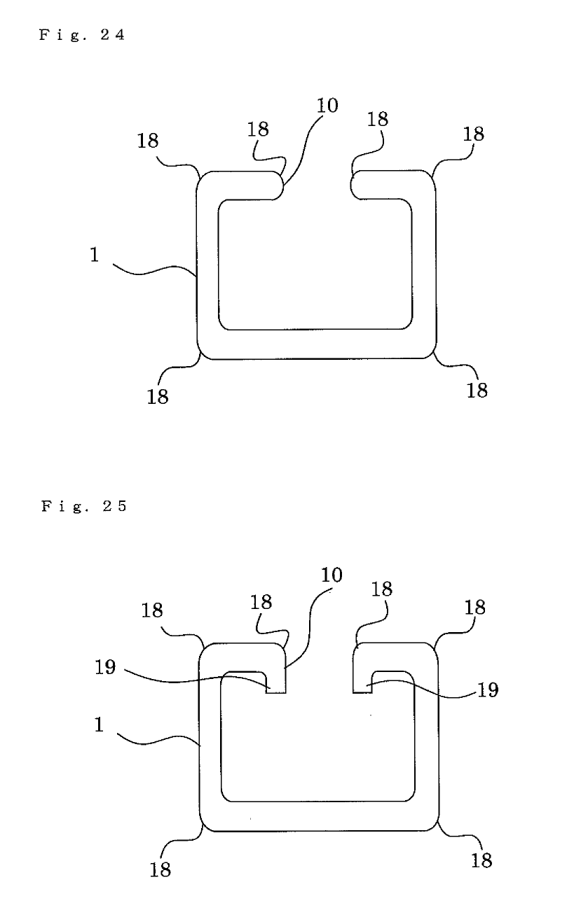

Embodiment 7 of the present invention will be described with reference to FIG. 21 and FIG. 22. FIG. 21 is a sectional view showing a conductor of a high voltage electrical apparatus according to Embodiment 7 of the present invention. FIG. 22 is a sectional view taken along the line X-X in FIG. 21, the sectional view showing the conductor of the high voltage electrical apparatus according to Embodiment 7 of the present invention. As is apparent from FIG. 22, there is shown the case where an opening portion 10 is formed in the left side surface of a polygonal tubular conductor 1 as an example, a first polygonal tubular conductor 1a and a second polygonal tubular conductor 1b are connected without using the bolts 6 and the nuts 7 as in the aforementioned respective embodiments. That is, a connection conductor that connects the first polygonal tubular conductor 1a and the second polygonal tubular conductor 1b is configured by a pair of opposing connection pieces 13 and 13 and pressing bodies 14 and 14. The pair of connection pieces 13 and 13 have contact portions 13a and 13a that come into contact with the upper surface and the lower surface of the inside of the first polygonal tubular conductor 1a and contact portions 13b and 13b that come into contact with the upper surface and the lower surface of the inside of the second polygonal tubular conductor 1b; and the pressing bodies 14 and 14 of, for example, compression springs are arranged between the pair of connection pieces 13 and 13 are arranged at the position between the contact portions 13a and 13a and at the position between the contact portions 13b and 13b.

In this Embodiment 7, the contact portions 13a and 13a and the contact portions 13b and 13b of the pair of connection pieces 13 and 13 press the upper surface and the lower surface of the first polygonal tubular conductor 1a and the upper surface and the lower surface of the second polygonal tubular conductor 1b with contact surface pressure being secured by spring force of the compression springs serving as the pressing bodies 14 and 14; and accordingly, the first polygonal tubular conductor 1a and the second polygonal tubular conductor 1b are connected. As a result, constituent elements configured by the pair of connection pieces 13 and 13 and the pressing bodies 14 and 14 can be achieved by very simple work that is insertion work; and accordingly, working man-hour can be reduced. Furthermore, these constituent elements are not exposed on the outside surfaces of the first polygonal tubular conductor 1a and the second polygonal tubular conductor 1b; and therefore, electric field relaxation can be prominently performed and withstand voltage performance can be remarkably improved.

### Embodiment 8

Embodiment 8 of the present invention will be described with reference to FIG. 23. FIG. 23 shows the case where a polygonal tubular conductor 1 is attached and supported to a porcelain insulator 15 placed near a conductor installation portion in a high voltage electrical apparatus. A threaded portion 16a of a bolt 16 is passed through a through hole 3 formed in the lower surface of the polygonal tubular conductor 1 via a washer 17 from the inside of the polygonal tubular conductor 1 and is screwed to a tapped hole 15a of the porcelain insulator 15 to firmly fix the polygonal tubular conductor 1 to the porcelain insulator 15 and thus the polygonal tubular conductor 1 is supported. An electric field is substantially uniform in the polygonal tubular conductor 1; and therefore, a special bolt 16 whose head portion 16b of the bolt 16 is formed in a round shape does not need to be used, a general and inexpensive bolt 16 is used, the polygonal tubular conductor 1 can be fixed to the porcelain insulator 15 while securing withstand voltage performance, and cost reduction can be achieved.

### Embodiment 9

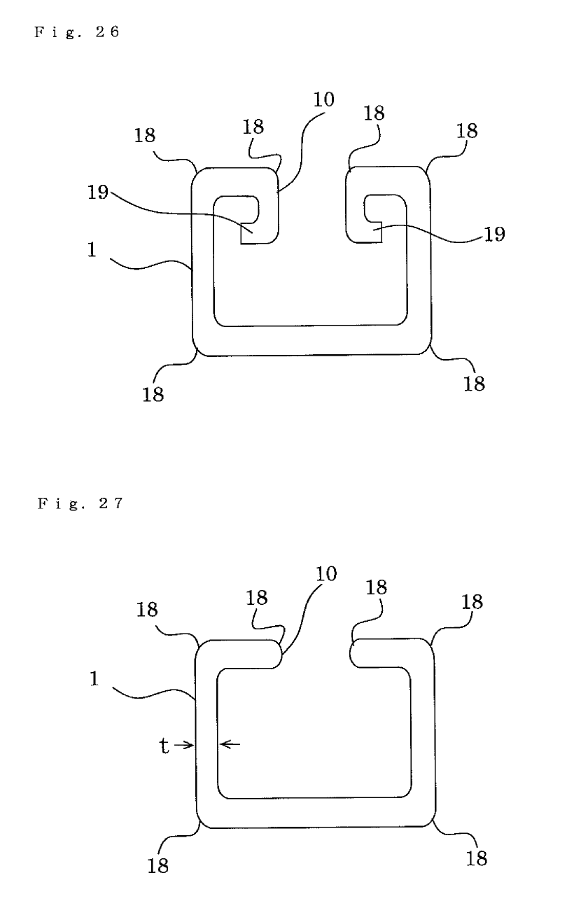

In the aforementioned respective embodiments, outer peripheral portions of the polygonal tubular conductor 1 are each formed at a right angle; and therefore, electric field relaxation is disturbed. Embodiment 9 further improves this; as shown in FIG. 24, a circular arc portion 18 is formed at each outer peripheral portion of a polygonal tubular conductor 1; and accordingly, an electric field generated near a corner portion of the outer peripheral portion can be relaxed and withstand voltage performance can be improved.

### Embodiment 10

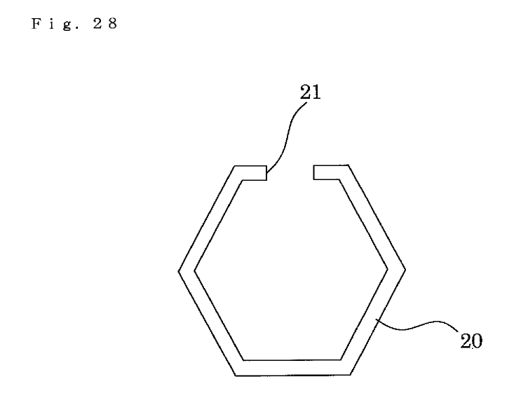

Furthermore, in the case where an opening portion 10 is formed in a polygonal tubular conductor 1, an opening end portion of the opening portion 10 has an edge portion and the edge portion disturbs relaxation of an electric field. In Embodiment 10, as shown in FIG. 25, a polygonal tubular conductor 1 is provided with opening end portions 19 of an opening portion 10, the opening end portions 19 being bent toward the inside of the polygonal tubular conductor 1; and accordingly, an electric field can be relaxed and withstand voltage performance can be further improved.

### Embodiment 11

In Embodiment 11, as shown in FIG. 26, opening end portions 19 of an opening portion 10 are further bent toward the side surface sides with respect to the polygonal tubular conductor 1 in the aforementioned Embodiment 10, and the same effects are exhibited.

### Embodiment 12

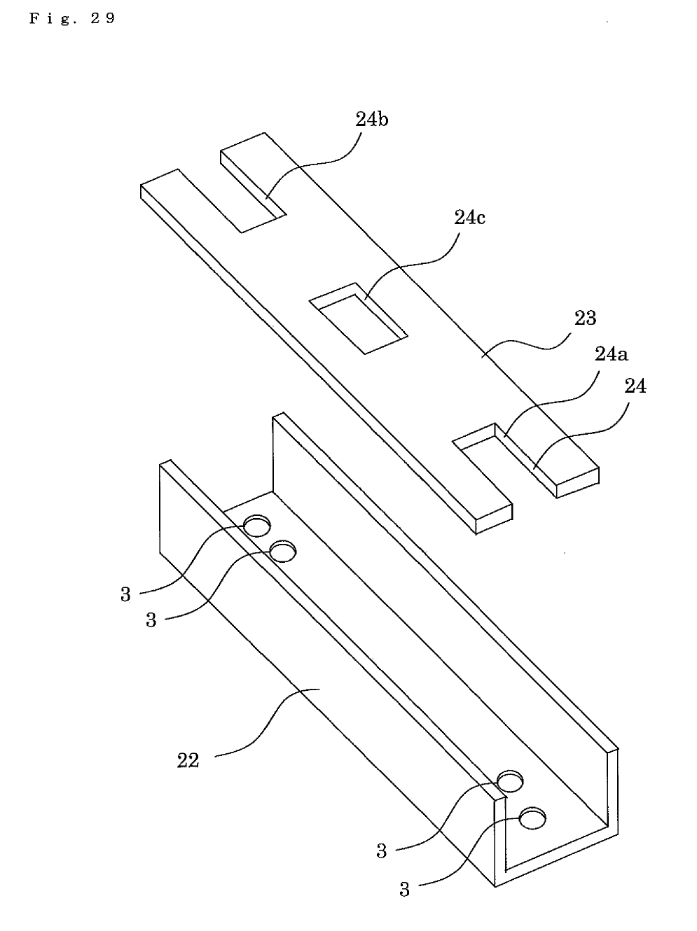

In Embodiment 12, as shown in FIG. 27, the thickness t of a polygonal tubular conductor 1 is not more than the thickness represented by the following equation.

$$t < \sqrt{\frac{2}{ω μ α }} \qquad [ Equation 1 ]$$

where, α denotes the conductivity of the conductor, μ denotes the permeability of the conductor, and ω denotes the angular frequency of alternating current. The equation shows the skin depth of current and the thickness is not more than this value; and accordingly, an active energization rate increases because the whole conductor contributes to energization.

### Embodiment 13

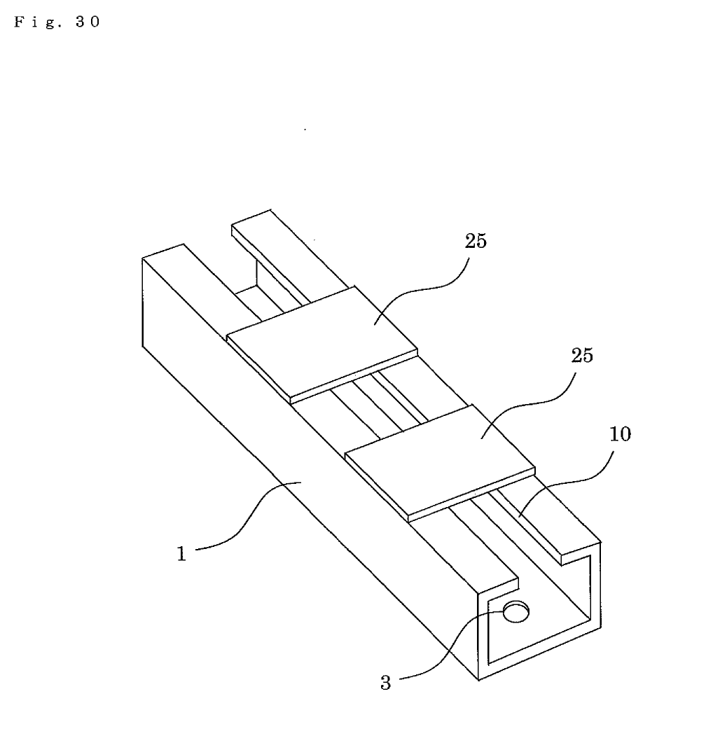

The description has been made on the case where the polygonal tubular conductors 1 in the aforementioned respective embodiments are each configured by a square tubular conductor; however, as shown in FIG. 28, a polygonal tubular conductor can be configured by a hexagonal tubular conductor 20 and is provided with an opening portion 21 that corresponds to the opening portions 10 of the aforementioned embodiments; and the same effects are exhibited.

### Embodiment 14

As shown in FIG. 29, Embodiment 14 shows a configuration example of the polygonal tubular conductor 1 of FIG. 1 in the aforementioned Embodiment 1. A conductor plate 23 in which opening portions 24a, 24b and 24c are formed is fixed to a concave conductor base portion 22 in which through holes 3 are formed; and accordingly, the configuration is the same as the polygonal tubular conductor 1 of FIG. 1 in the aforementioned Embodiment 1.

### Embodiment 15

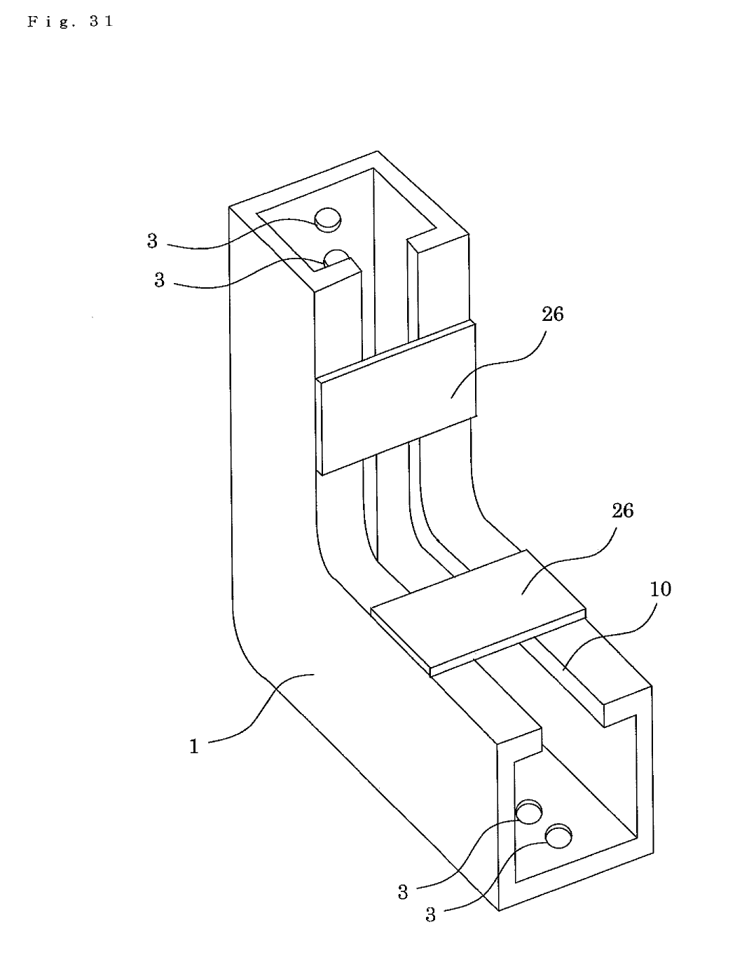

As shown in FIG. 30, Embodiment 15 shows a configuration example of the polygonal tubular conductor 1 of FIG. 1 in the aforementioned Embodiment 1. That is, blocking conductors 25 are fixed with an arbitrary interval to an opening portion 10, the opening portion 10 being formed in the polygonal tubular conductor 1 shown in FIG. 5, and the opening portion 10 is remained at both end portions and a central portion of the polygonal tubular conductor 1; and accordingly, the configuration is the same as the polygonal tubular conductor 1 of FIG. 1 in the aforementioned Embodiment 1.

### Embodiment 16

As shown in FIG. 31, Embodiment 16 shows a configuration example of the polygonal tubular conductor 1 of FIG. 4 in the aforementioned Embodiment 1. That is, blocking conductors 26 are fixed with an arbitrary interval to an opening portion 10, the opening portion 10 being formed in the polygonal tubular conductor 1 shown in FIG. 7, and the opening portion 10 is remained at both end portions and a central portion of the polygonal tubular conductor 1; and accordingly, the configuration is the same as the polygonal tubular conductor 1 of FIG. 1 in the aforementioned Embodiment 1.

### INDUSTRIAL APPLICABILITY

The present invention is suitable for a conductor of a high voltage electrical apparatus such as a gas insulated switchgear, the conductor being placed in a vessel filled with insulating gas such as SF₆ gas together with an electrical apparatus, and the conductor of the high voltage electrical apparatus being capable of achieving reduction in cost and high reliability.

1-11. (canceled)

12. A conductor of a high voltage electrical apparatus, said conductor being placed in a vessel filled with insulating gas together with an electrical apparatus,
wherein said conductor is configured by a polygonal tubular conductor, and an opening portion serving as a path of the insulating gas is formed in at least one surface of said polygonal tubular conductor,
said polygonal tubular conductor being configured by a first polygonal tubular conductor and a second polygonal tubular conductor; and
further comprising a connection conductor and fasteners,
said first polygonal tubular conductor and said second polygonal tubular conductor being connected by said connection conductor and being fastened with said fasteners,
fastening portions of said first polygonal tubular conductor and said second polygonal tubular conductor being formed with concave portions each located on the side of said first polygonal tubular conductor and on the side of said second polygonal tubular conductor, and head portions of said fasteners being contained in the concave portions.

13. The conductor of the high voltage electrical apparatus according to claim 12,
wherein the opening portion formed in said polygonal tubular conductor is formed at both end portions of said polygonal tubular conductor and between the both end portions.

14. The conductor of the high voltage electrical apparatus according to claim 12,
wherein the opening portion formed in said polygonal tubular conductor is an opening portion which is brought into communication with both end portions of said polygonal tubular conductor.

15. The conductor of the high voltage electrical apparatus according to claim 12,
wherein said connection conductor is placed at the outer surface side of said first polygonal tubular conductor and said second polygonal tubular conductor.

16. The conductor of the high voltage electrical apparatus according to claim 15,
wherein a fastening portion of said connection conductor is formed with a concave portion, and a head portion of said fastener is contained in the concave portion.

17. The conductor of the high voltage electrical apparatus according to claim 12,
wherein said connection conductor which connects said first polygonal tubular conductor and said second polygonal tubular conductor is configured by a pair of opposing connection pieces,
said fasteners of compression springs are arranged between said pair of connection pieces, and
said pair of connection pieces being made to come in contact with said first polygonal tubular conductor and said second polygonal tubular conductor by spring force of said compression springs so as to connect.

18. The conductor of the high voltage electrical apparatus according to claim 12,
wherein an outer corner portion of said polygonal tubular conductor is formed with a circular arc portion that promotes relaxation of an electric field.

19. The conductor of the high voltage electrical apparatus according to claim 15,
wherein an outer corner portion of said polygonal tubular conductor is formed with a circular arc portion that promotes relaxation of an electric field.

20. The conductor of the high voltage electrical apparatus according to claim 16,
wherein an outer corner portion of said polygonal tubular conductor is formed with a circular arc portion that promotes relaxation of an electric field.

21. The conductor of the high voltage electrical apparatus according to claim 17,
wherein an outer corner portion of said polygonal tubular conductor is formed with a circular arc portion that promotes relaxation of an electric field.

22. The conductor of the high voltage electrical apparatus according to claim 14,
wherein an opening end portion of the opening portion which is formed in said polygonal tubular conductor and is brought into communication between both end portions thereof is bent toward the inside of said polygonal tubular conductor.

23. The conductor of the high voltage electrical apparatus according to claim 12,
wherein said polygonal tubular conductor is configured by a square tube conductor.

24. The conductor of the high voltage electrical apparatus according to claim 15,
wherein said polygonal tubular conductor is configured by a square tube conductor.

25. The conductor of the high voltage electrical apparatus according to claim 16,
wherein said polygonal tubular conductor is configured by a square tube conductor.
wherein said light source mirror is made of aluminum.

26. The conductor of the high voltage electrical apparatus according to claim 17,
wherein said polygonal tubular conductor is configured by a square tube conductor.

27. The conductor of the high voltage electrical apparatus according to claim 18,
wherein said polygonal tubular conductor is configured by a square tube conductor.

28. The conductor of the high voltage electrical apparatus according to claim 19,
wherein said polygonal tubular conductor is configured by a square tube conductor.

29. The conductor of the high voltage electrical apparatus according to claim 20,
wherein said polygonal tubular conductor is configured by a square tube conductor.

30. The conductor of the high voltage electrical apparatus according to claim 21,
wherein said polygonal tubular conductor is configured by a square tube conductor.

31. The conductor of the high voltage electrical apparatus according to claim 22,
wherein said polygonal tubular conductor is configured by a square tube conductor.
